(19) United States
(12) Patent Application Publication
(10) Pub. No.: US 2012/0048912 A1
(43) Pub. Date: Mar. 1, 2012

(54) METHODS FOR THE FORMATION OF MCrAlY COATINGS ON GAS TURBINE ENGINE COMPONENTS

(75) Inventors: Yiping Hu, Greer, SC (US); Richard L. Bye, Morristown, NJ (US)

(73) Assignee: HONEYWELL INTERNATIONAL INC., Morristown, NJ (US)

(21) Appl. No.: 12/869,464

(22) Filed: Aug. 26, 2010

(51) Int. Cl. B23K 31/02

(52) U.S. Cl. 228/119; 228/125; 228/256; 228/259; 228/261

(57) ABSTRACT

Embodiments of a method for forming an MCrAlY coating on a gas turbine engine component are provided, as are embodiments of a method for repairing a structurally-damaged region of a gas turbine engine component utilizing an MCrAlY material. In one embodiment, the method includes the step of preparing an MCrAlY slurry containing an MCrAlY powder, a low melting point powder, a binder, and a dilutant. After application over the gas turbine engine component, the MCrAlY slurry is heated to a predetermined temperature that exceeds the melting point of the low melting point powder to form an MCrAlY coating on the gas turbine engine component. The MCrAlY powder may have any one of a number of different compositions.

### TECHNICAL FIELD

The following disclosure relates generally to gas turbine engines and, more particularly, to embodiments of a method for depositing MCrAlY coatings on gas turbine engine components.

### BACKGROUND

As the operating temperature of a gas turbine engine (“GTE”) increases, so too does the engine's efficiency. The maximum operating temperature of a gas turbine engine is, however, limited by the ability of hot section components (e.g., combustor liners, turbine seals, turbine blades, nozzle guide vanes, duct members, and the like) to withstand direct exposure to high temperature gas flow without excessive structural degradation due to hot corrosion, oxidation, thermal fatigue, and erosion. Extensive engineering efforts have resulted in various advances in cooling techniques, superalloy materials, and coating systems (e.g., thermal barrier and environmental barrier coatings), which have collectively increased the operational temperature limits of modern GTEs by several hundred degrees Fahrenheit within the past few decades.

It is, of course, desirable to reduce cost in both the fabrication and the repair of hot section components. While many newly-manufactured hot section components are applied with environmental barrier coatings (e.g., dual layer platinum-modified aluminide/MCrAlY coatings), the production and the application of such protective coatings can add considerable cost to the hot section component fabrication. For example, while platinum-modified aluminide coatings provide excellent oxidation resistance and good corrosion resistance, such coatings are especially costly to produce due, in large part, to their requisite platinum content. In addition, application of a platinum-modified aluminide coating to a selected hot section component typically entails the performance of multiple time consuming steps; e.g., plating, diffusion heat treatment, aluminizing processes such as pack or above pack aluminizing, chemical vapor deposition, and heat treatment steps. By comparison, MCrAlY coatings have lower raw material costs and provide good oxidation and excellent corrosion resistance. However, conventional application techniques utilized to deposit MCrAlY coatings (e.g., low pressure plasma spraying and electron beam physical vapor deposition processes) are also undesirably complex and costly to perform. There thus exists an ongoing need to provide embodiments of a lower cost process for forming an MCrAlY coating on a gas turbine engine component. Ideally, embodiments of such a low cost process would produce a metallurgically sound coating providing oxidation and corrosion protection properties equivalent to or surpassing those of conventionally-deposited MCrAlY coatings.

It is further desirable to reduce costs in the repair of hot section components that have, for example, cracked or eroded as a result of prolonged exposure to hot combustive gas. Several innovative processes have been developed to repair damaged areas of hot section components through crack healing and restoration of eroded surfaces to original dimensions and contours. However, conventional repair techniques typically cannot provide improved corrosion and oxidation resistance to the restored area of the component beyond that provided by the component's parent material. Thus, after reinstallation and subsequent usage of the refurbished component, the repaired area may again erode, crack, or otherwise suffer structural damage in the presence of combustive gas flow and further repair may become necessary. There thus further exists an ongoing need to provide embodiments of a method for repairing a damaged (e.g., eroded or cracked) area of a hot section component (e.g., a turbine airfoil) utilizing materials that provide improved oxidation and corrosion protection. Other desirable features and characteristics of the present invention will become apparent from the subsequent Detailed Description and the appended Claims, taken in conjunction with the accompanying Drawings and this Background.

### BRIEF SUMMARY

Embodiments of a method for forming an MCrAlY coating on a gas turbine engine component are provided. In one embodiment, the method includes the step of preparing an MCrAlY slurry containing an MCrAlY powder, a low melting point powder, a binder, and a dilutant. After application over the gas turbine engine component, the MCrAlY slurry is heated to a predetermined temperature that exceeds the melting point of the low melting point powder to form an MCrAlY coating on the gas turbine engine component. In a first exemplary implementation of the foregoing method, the MCrAlY powder includes about 8-15 wt. % aluminum; about 15-25 wt. % chromium; about 15-22 wt. % cobalt; about 0-3 wt. % zirconium; about 0.1-1 wt. % yttrium; about 0-5 wt. % of each of hafnium, rhenium, ruthenium, silicon, and tantalum; and the balance nickel. In a second exemplary implementation, the MCrAlY powder includes about 7.5-8.5 wt. % aluminum, about 20-22 wt. % chromium, about 38-40 wt. % cobalt, about 0.2-0.60 wt. % yttrium, and the balance nickel. In a third exemplary implementation, the MCrAlY powder includes about 11.5-13.5 wt. % aluminum; about 18-20 wt. % chromium; about 20-22 wt. % cobalt; about 0.15-0.5 wt. % hafnium; about 0.2-0.6 wt. % of each of silicon and yttrium; and the balance nickel.

Methods for forming an MCrAlY coating on a structurally-damaged area of a gas turbine engine component to repair the structurally-damaged area are further provided. In one embodiment, the method includes the step of preparing an MCrAlY slurry containing an MCrAlY powder, a braze powder, a binder, and a dilutant. After application over the structurally-damaged area of the gas turbine engine component, the MCrAlY slurry is heated to a predetermined temperature surpassing the melting point of the braze powder to form an MCrAlY coating on the structurally-damaged area of the gas turbine engine component.

### BRIEF DESCRIPTION OF THE DRAWINGS

At least one example of the present invention will hereinafter be described in conjunction with the following figures, wherein like numerals denote like elements, and:

FIG. 1 is a flowchart illustrating an exemplary method for forming a MCrAlY coating over one or more surfaces of a selected gas turbine engine component; and

FIG. 2 is a graph of corrosion testing data illustrating the corrosion resistance of a first superalloy substrate having a slurry-deposited MCrAlY coating formed thereof relative to the corrosion resistances of two uncoated superalloy substrates.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

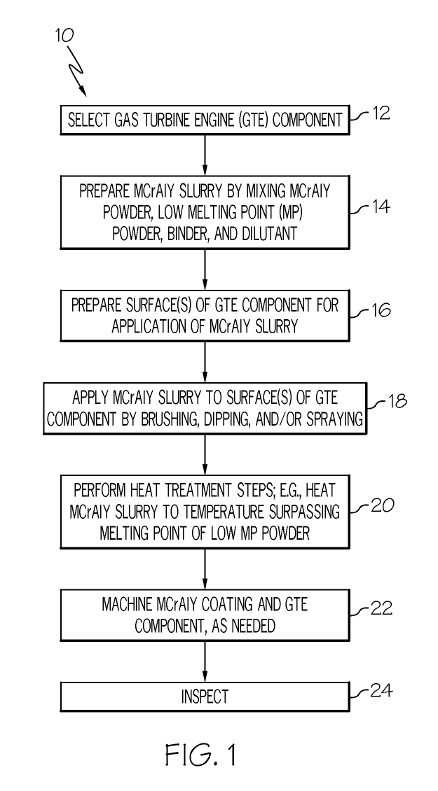

FIG. 1 is a flowchart illustrating an exemplary method 10 suitable for forming a slurry-deposited MCrAlY coating on one or more surfaces of a gas turbine engine (“GTE”) component. In certain embodiments, method 10 provides a novel manner in which advanced MCrAlY coatings having enhanced environmentally-protective properties (e.g., improved corrosion and oxidation resistance) can be formed on newly-manufactured GTE components, as well as on pre-existing components not requiring repair. In other embodiments, method 10 provides a novel repair technique that can be utilized to rebuild or otherwise restore damaged areas (e.g., eroded and/or cracked areas) of GTE components with MCrAlY-based materials often having superior corrosion and oxidation resistant properties, as compared to conventionally-employed repair materials and to the superalloy parent material form which the GTE component is fabricated. In either case, exemplary method 10 involves preparation of an unique MCrAlY-based slurry that can be applied to a selected GTE component utilizing a relatively inexpensive and straightforward application technique, such as brushing, dipping, or spraying. After application, the MCrAlY slurry is heat treated to form a highly dense, adherent MCrAlY coating having exceptional corrosion and oxidation resistive properties, as described more fully below. The steps illustrated in FIG. 1 and described below are, of course, provided by way of example only; in alternative embodiments of method 10, additional steps may be performed, certain steps may be omitted, and/or the steps may be performed in alternative sequences.

It is noted that, in embodiments wherein the below-described method is utilized to repair a structurally damaged gas turbine engine component, the method will typically include one or more steps similar to the steps of the JetFix® process developed by Honeywell International, Inc., headquartered in Morristown, N.J. However, embodiments of the exemplary method described herein differ from the conventionally-performed JetFix® process in several manners, including in the production and application of an MCrAlY-based slurry. Thus, in a general sense, embodiments of the below-described method provide an improved JetFix® process that can be performed at reduced cost to restore structurally-damaged GTE components utilizing a slurry-deposited MCrAlY material having improved corrosion and oxidation resistive properties, as described above.

With reference to FIG. 1, method 10 commences with the selection of a GTE component on which the MCrAlY coating is to be formed (STEP 12, FIG. 1). The selected GTE component may be any structural element or assemblage of structural elements included within a gas turbine engine and exposed to elevated temperatures during engine operation. To list but a few examples, the GTE component may be a combustor liner, a turbine seal, a turbine shroud, a turbine blade, a nozzle guide vane, or a duct member. As indicated above, the GTE component may be newly-manufactured; engine-run, but not requiring structural damage repair; or engine-run and requiring repair due to structural damage (e.g., material loss and/or cracking) As will become apparent during the course of the subsequent description, the type of GTE component selected during STEP 12 (in particular, whether the selected component is in need of repair) will generally determine various aspects of the latter-performed steps included within method 10. In embodiments wherein method 10 is utilized as a low cost means of applying an MCrAlY overlay coating on a new or undamaged GTE component, method 10 may be especially useful for repairing first and second stage vane segments included within certain types of gas turbine engines, such as auxiliary power units, and subjected to combustive gas flow temperatures ranging from approximately 925° C. to approximately 1150° C. during engine operation. By comparison, in embodiments wherein method 10 is utilized to repair GTE components having structural damage (e.g., material loss or cracking), method 10 may be especially useful for repairing either low-end (or low pressure turbine) vane airfoils included within auxiliary power units or hot section components included within older aero-engines operated at temperatures between approximately 925° C. and approximately 1205° C.

After selection of the GTE component (STEP 12, FIG. 1), the MCrAlY slurry is prepared (STEP 14, FIG. 1). Preparation of the MCrAlY slurry preferably begins by mixing at least two powders, namely, an MCrAlY powder and a low melting point (“mp”) powder. As appearing, the term “low melting point powder” is utilized to denote a powdered material (e.g., a powdered metal or alloy) having a melting point lower than the melting point of the selected MCrAlY powder and of the substrate material (e.g., the superalloy from which the GTE component is fabricated). Similarly, the term “low melting point alloy” is utilized herein to denote a powder containing at least two metallic elements and having a melting point lower than the melting point of the MCrAlY powder and the melting point of the substrate material. The MCrAlY powder and low mp powder are combined in a predetermined weight ratio, which will vary depending upon the desired metallurgical, mechanical, and environmentally-protective properties of the subsequently-formed MCrAlY coating and upon the composition of the low mp powder. Generally, in embodiments wherein method 10 is utilized to repair a damaged GTE component, the MCrAlY powder and low mp powder are preferably mixed in a predetermined ratio ranging from approximately 50 wt. % to approximately 60 wt. % MCrAlY powder with approximately 40 wt. % to approximately 50 wt. % low mp powder (e.g., a nickel- or cobalt-based braze alloy, as described below); and, in embodiments wherein method 10 is utilized to form an environmentally-protective overlay coating on a new (or otherwise undamaged) GTE component, the MCrAlY powder and low mp powder are preferably mixed in a predetermined ratio ranging from approximately 70 wt. % to approximately 80 wt. % MCrAlY powder with approximately 20 wt. % to approximately 30 wt. % low mp powder (e.g., an aluminum or aluminum-silicon powder, as described below). The MCrAlY powder and the low mp powder are conveniently mixed utilizing, for example, a standard ball mill.

In addition to its named components (i.e., chromium, aluminum, yttrium, and “M,” wherein M represents nickel, cobalt, or a combination thereof), the MCrAlY powder can, and typically will, include lesser amounts of one or more additional metallic or non-metallic constituents, which may be added in powder form to a master alloy during processing to optimize desired metallurgical properties, such as oxidation and corrosion resistance, of the resulting MCrAlY coating. In a preferred group of embodiments, an MCrAlYX powder is utilized wherein X comprises one or more of the following elements: hathium, rhenium, ruthenium, platinum, palladium, silicon, tantalum, titanium, lanthanum, cerium, and zirconium. TABLES 1-3 below provide exemplary compositions of an MCrAlYX powder well-suited usage in implementations of exemplary method 10 utilized to repair damaged GTE components, as well as in implementations of method 10 utilized to form environmentally-protective overlay coatings on newly-manufactured or pre-existing, non-damaged GTE components. The values set-forth in TABLES 1-3 below are approximations of the maximum and minimum weight percentages of each component included within the MCrAlYX powder.

TABLE 1
First Exemplary MCrAlYX Powder

| | Minimum | Maximum |
|---|---|---|
| Component | Weight % | Weight % |
| Aluminum | 8.0 | 15 |
| Chromium | 15 | 25 |
| Cobalt | 15 | 22 |
| Hafnium | 0 | 5.0 |
| Nickel | Bal | Bal |
| Rhenium | 0 | 5.0 |
| Ruthenium | 0 | 5.0 |
| Silicon | 0 | 5.0 |
| Tantalum | 0 | 5.0 |
| Yttrium | 0.10 | 1.0 |
| Zirconium | 0 | 3.0 |

TABLE 2
Second Exemplary MCrAlYX Powder

| | Minimum | Maximum |
|---|---|---|
| Component | Weight % | Weight % |
| Aluminum | 7.5 | 8.5 |
| Chromium | 20 | 22 |
| Cobalt | 38 | 40 |
| Nickel | Bal | Bal |
| Yttrium | 0.20 | 0.60 |

TABLE 3
Third Exemplary MCrAlYX Powder

| | Minimum | Maximum |
|---|---|---|
| Component | Weight % | Weight % |
| Aluminum | 11.5 | 13.5 |
| Chromium | 18 | 20 |
| Cobalt | 20 | 22 |
| Hafnium | 0.15 | 0.50 |
| Nickel | Bal | Bal |
| Silicon | 0.20 | 0.60 |
| Yttrium | 0.20 | 0.60 |

The composition of the low mp powder will typically be determined, at least in part, by whether the MCrAlY slurry is intended to form an environmental coating on an undamaged GTE component or, instead, to repair a structurally-degraded area of a service-run GTE component. In embodiments wherein the MCrAlY slurry is intended to form an environmental barrier coating on an undamaged GTE component, the low mp powder is preferably an aluminum-containing powder and, more preferably, an aluminum powder or an aluminum-silicon powder. An aluminum-silicon powder having a preferred composition is set-forth in TABLE 4 below. The values set-forth in TABLE 4 below are approximations of the maximum and minimum weight percentages of each component included within the aluminum-silicon powder.

TABLE 4
First Exemplary Low MP (Non-Braze) Powder

| | Minimum | Maximum |
|---|---|---|
| Component | Weight % | Weight % |
| Aluminum | 92.0 | 96.0 |
| Silicon | 4.0 | 8.0 |

In embodiments wherein the MCrAlY slurry is utilized to repair structural damage of an engine-run GTE component, the low mp powder preferably comprises a braze alloy, such as a nickel- or cobalt-based braze alloy. Three braze alloys well-suited for usage in embodiments wherein the MCrAlY slurry is utilized for repair purposes are set-forth in TABLES 5-7 below. As previously indicated, the values set-forth in TABLES 5-7 below are approximations of the maximum and minimum weight percentages of each component included within the braze powder.

TABLE 5
First Exemplary Low MP (Braze) Powder

| | Minimum | Maximum |
|---|---|---|
| Component | Weight % | Weight % |
| Aluminum | 3.6 | 5.2 |
| Boron | 2.3 | 3.2 |
| Carbon | 0.02 | 0.06 |
| Chromium | 6.7 | 9.2 |
| Cobalt | 9.7 | 10.3 |
| Hafnium | 1.3 | 4.0 |
| Nickel | Bal | Bal |
| Rhenium | 1.4 | 3.2 |
| Tantalum | 3.3 | 6.3 |
| Tungsten | 3.7 | 4.7 |

TABLE 6
Second Exemplary Low MP (Braze) Powder

| | Minimum | Maximum |
|---|---|---|
| Component | Weight % | Weight % |
| Carbon | 0.4 | 0.8 |
| Boron | 2.5 | 3.0 |
| Chromium | 22.5 | 23.5 |
| Cobalt | Bal | Bal |
| Nickel | 9.5 | 10.5 |
| Tantalum | 3.3 | 3.9 |
| Titanium | 0.10 | 0.30 |
| Tungsten | 6.5 | 7.5 |
| Yttrium | 0.03 | 0.07 |
| Zirconium | 0.3 | 0.7 |

TABLE 7
Third Exemplary Low MP (Braze) Powder

| | Minimum | Maximum |
|---|---|---|
| Component | Weight % | Weight % |
| Aluminum | 3.2 | 4.0 |
| Boron | 2.5 | 3.0 |
| Chromium | 13.5 | 14.5 |
| Cobalt | 9.5 | 10.5 |
| Nickel | Bal | Bal |
| Tantalum | 2.2 | 2.8 |
| Yttrium | 0.05 | 0.15 |

Next, during STEP 12 of exemplary method 10 (FIG. 1), a chemical binder, such as a custom prepared binder solution or a commercially-available binder like B215, is introduced into the MCrAlY plus low mp powder mixture to produce an MCrAlY slurry. Although other binders may be employed, in one embodiment, a binder solution is employed that comprises a phosphate/chromate solution containing approximately 30 wt. % phosphate and approximately 60 wt. % chromate. In another embodiment, commercially-available chemical binder like B215 is used to prepare the MCrAlY slurry. The resulting MCrAlY slurry may then be diluted to a desired viscosity to facilitate application via brushing, dipping, or spraying, as described below. In a preferred embodiment, the MCrAlY slurry is diluted with an alcohol, such as isopropanol. Although the weight percentages will inevitably vary amongst different embodiments, 10 wt. % binder and 15 wt. % alcohol may be added to the MCrAlY plus low mp powder mixture to produce the final MCrAlY slurry. If desired, the slurry may be milled, mixed, or blended to obtain a desired range of particle sizes and/or a uniform consistency. Advantageously, the final diluted MCrAlY slurry can be stored in a ready-to-use state for extended periods of time without significant deterioration of its properties.

Continuing with exemplary method 10 (FIG. 1), one or more surfaces of the selected GTE component are next prepared for application of the MCrAlY slurry (STEP 16, FIG. 1). During STEP 16, the surface or surfaces of the selected GTE component may be cleaned utilizing, for example, a de-greasing agent. In embodiments wherein the MCrAlY slurry is to be applied on an area of the GTE component having structural damage (e.g., material loss or cracking), a hydrogen fluoride ion cleaning may further be performed to remove deeply embedded oxides. In embodiments wherein the MCrAlY slurry is to be applied on an undamaged surface of a GTE component, the surface or surfaces of the GTE component may be grit blasted during STEP 16 utilizing, for example, a nickel, silicon carbide, or aluminum oxide grit, depending, at least in part, upon which of the MCrAlY slurry types is to be applied.

Next, during STEP 18 (FIG. 1), the MCrAlY slurry is applied to the surface or surfaces of the selected GTE component. Due to its dilute nature, the MCrAlY slurry can easily be applied by brushing, dipping, or spraying. Notably, such techniques are considerably less costly to perform than are other deposition techniques, such as plasma spraying and electron beam physical vapor deposition, traditionally utilized to deposit non-slurry MCrAlY coatings. The MCrAlY slurry will typically be applied in successive coats to a desired thickness. If utilized as an environmentally-protective overlay coating, the MCrAlY slurry is conveniently deposited to a thickness between approximately 0.125-1.0 millimeters. If utilized to build-up an eroded region of the GTE component, the thickness to which the MCrAlY slurry will be deposited will depend upon the original dimensions of the GTE component; however, in general, the MCrAlY slurry will typically deposited to a thickness of approximately 0.10 to approximately 1.0 millimeters or more.

After application of the MCrAlY slurry (STEP 18, FIG. 1), one or more heat treatment steps are performed (STEP 20, FIG. 1). The heat treatment steps and the parameters (e.g., duration, temperature, and environment) of each heat treatment step will vary amongst different embodiments of method 10 depending, at least in part, upon the melting point of the low mp powder contained within the MCrAlY slurry. Heat treatment of the MCrAlY slurry includes at least one thermal processing step wherein the MCrAlY slurry is heated to a temperature exceeding the melting point of the low mp powder to melt the low mp powder and thereby form a metallurgically dense, adhesive MCrAlY coating on the GTE component (commonly referred to as “densification”) and to promote sintering of the coating's other components. Additionally, in embodiments wherein the GTE component includes at least one crack, the melted braze powder along with the MCrAlY powder flows into the crack or cracks due to capillary action during thermal processing and heals the cracks upon solidification. In a preferred embodiment, at least one curing step is performed prior the above-described thermal processing step to evaporate the dilutant from the MCrAlY slurry and at least one diffusion heating step is performed after the thermal processing step to homogenize and consolidate the final MCrAlY coating. Specific examples of the various heat treatment steps that may be performed during STEP 20 of exemplary method 10 are described more fully below.

In a first exemplary embodiment wherein method 10 is performed to repair a GTE component having structural damage, the following steps may be performed during STEP 20 (FIG. 1): (i) a curing step wherein the MCrAlY slurry and the repaired GTE component are heated to a relatively low temperature (e.g., approximately 95° C.) for a first predetermined time period (e.g., 2-4 hours) to evaporate the dilutant; (ii) a primary heat treatment step wherein the MCrAlY slurry and the GTE component are heated to a relatively high temperature (e.g., approximately 1205° C.) under vacuum for a second predetermined time period (e.g., approximately 30 minutes) to promote densification and sintering of the resulting MCrAlY coating; and (iii) a diffusion step wherein the MCrAlY slurry and the GTE component are heated to an intermediate temperature (e.g., approximately 1095° C. to approximately 1175° C. for a third predetermined time period (e.g., approximately 2-8 hours) to promote diffusion and homogenization of the MCrAlY coating constituents.

In a second exemplary embodiment wherein method 10 is performed to form an environmentally-protective overlay coating on a new or otherwise undamaged GTE component, the following steps may be performed during STEP 20 (FIG. 1): (i) a curing step wherein the MCrAlY slurry and the repaired GTE component are heated to a relatively low temperature (e.g., approximately from 65° C. to 370° C.). for a first predetermined time period (e.g., 0.25-2 hours) to evaporate the dilutant; (ii) a primary heat treatment wherein the MCrAlY slurry and the GTE component are heated to an intermediate temperature (e.g., approximately 1650° F.) for a second predetermined time period (e.g., approximately 1-2 hours) to promote densification and sintering of the resulting the MCrAlY coating; and (iii) a diffusion step wherein the MCrAlY slurry and the GTE component are heated to a relatively high temperature (e.g., approximately 1040° C.-1095° C.) for a third predetermined time period (e.g., approximately 2-6 hours) to promote diffusion and homogenization of the MCrAlY coating constituents.

At this juncture in exemplary method 10, one or more machining steps are optionally performed (STEP 22, FIG. 1). In particular, in embodiments wherein the MCrAlY coating is built-up on a surface of the selected GTE component to replace lost material, the MCrAlY coating may be mechanically ground, polished, or otherwise smoothed to restore the repaired area to its original dimensions and contours; e.g., the repaired area may be hand finished with an abrasive tool. Lastly, at STEP 24 (FIG. 1), inspection is performed to ensure that the slurry-deposited MCrAlY coating is substantially free of structural defects. In embodiments wherein the MCrAlY coating is utilized to repair a damaged area (e.g., a cracked or eroded area of the selected GTE component, inspection may be performed utilizing a common non-destructive evaluation tool, such as a fluorescent penetrant inspection. In embodiments wherein the MCrAlY coating serves as an environmentally-protective overlay formed on a new or otherwise undamaged GTE component, a simple visual inspection may suffice.

The foregoing has thus provided multiple exemplary embodiments of a method for forming a unique slurry-deposited MCrAlY coating over gas turbine engine components. In certain embodiments, the above-described method is especially useful in the formation of environmentally-protective overlay coatings over newly-manufactured or otherwise undamaged GTE components. In other embodiments, the above-described method is especially useful in repair of GTE components having structural damage (e.g., cracking or material loss). In either case, the MCrAlY slurry is applied utilizing a relatively straightforward and low cost application technique, such as brushing, dipping, or spraying; and is heat treated to form a highly dense, adhesive MCrAlY coating having exceptional corrosion and oxidation resistance over a gas turbine engine component.

Corrosion Testing Example

Corrosion testing was performed on an embodiment of the MCrAlY slurry coating formed over a substrate fabricated from MM247, a nickel-based superalloy commonly service-run for turbine engine components such as blades and vanes. For comparison purposes, two uncoated alloy superalloy specimens were also tested from MM247 and HS188, a cobalt based superalloy with good corrosion resistance that is commonly used in turbine engine components such as combustions cans and transition ducts.

Button samples approximately 25.4 mm in diameter by 3.2 mm in thickness were machined from MM247 and HS188. Some of the MM247 samples were coated with a slurry-deposited environmental overlay coating of the type described above. The surfaces of all of the samples were sanded and wet blasted using 240 mesh silica grit. The surfaces of the samples were then ultrasonically cleaned in toluene. An aqueous solution of sodium sulfate (NaSO₄) and magnesium sulfate (MgSO₄) in a 60:40 ratio, by weight, was applied to one face of the button samples so as to leave approximately 5 mg of salts on the surface after drying. The samples were then place in a low temperature oven (about 40° C. to 90° C.) until the salt solution was dry.

Five samples of each test condition (MCrAlY braze-coated MM247, bare MM247, and bare HS188) were placed in a furnace chamber maintained at 900° C. Periodically, the samples were removed from the furnace, ultrasonically cleaned in toluene, dried, and then weighed in order to determine the weight change as a function of the number of hours exposed to 900° C. After weighing, the salt solution was reapplied to all of the samples as described above, and then returned to the furnace for continued testing.

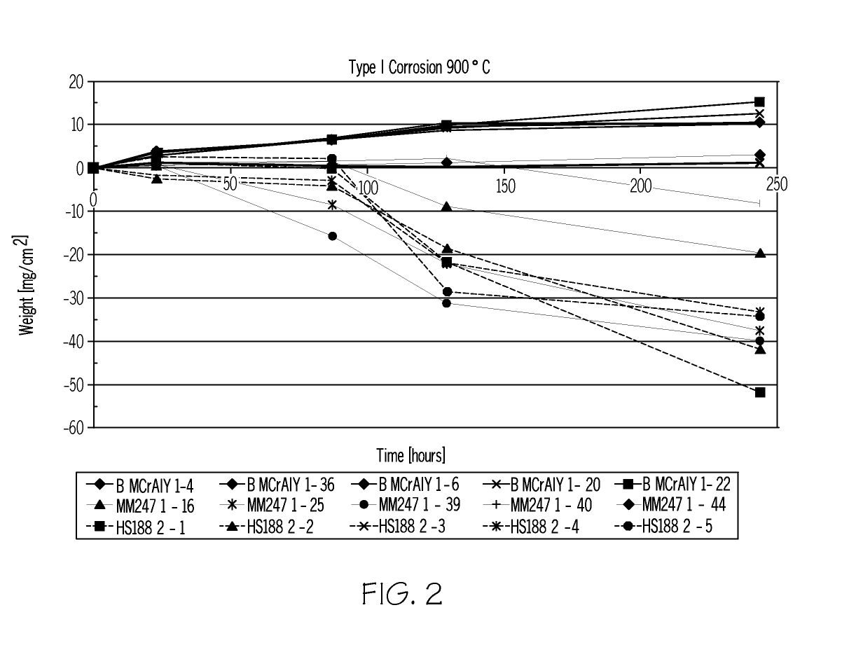

FIG. 2 is a graph summarizing the results of the above-described corrosion test. In FIG. 2, the weight change for each sample is divided by the original sample surface area and then plotted against the number of hours of exposure to 900° C. Plot lines for the braze-coated MM247 sample are identified in FIG. 2 as “B MCrAlY.” As can be seen, the MCrAlY braze-coated MM247 sample demonstrated superior corrosion resistance as compared to both the MM247 and HS188 samples.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

1. A method for forming an MCrAlY coating over a gas turbine engine component, the method comprising:
preparing an MCrAlY slurry comprising an MCrAlY powder, a low melting point powder, a binder, and a dilutant;
applying the MCrAlY slurry on the gas turbine engine component; and
heating the MCrAlY slurry to a predetermined temperature that exceeds the melting point of the low melting point powder to form an MCrAlY coating over the gas turbine engine component;
wherein the low melting point powder is selected from the group consisting of an aluminum powder and an aluminum-silicon powder.

2. A method according to claim 1 wherein the step of applying comprises brushing, dipping, spraying, or a combination thereof.

3. A method according to claim 1 wherein the low melting point powder comprises an aluminum-silicon powder consisting essentially of:
about 92.0-96.0 wt. %; and
about 4.0-8.0 wt. % silicon.

4. A method according to claim 1 wherein the dilutant comprises an alcohol, and wherein the method further comprises the step of curing the MCrAlY slurry to evaporate at least a portion of the alcohol therefrom, the step of curing performed prior to the step of heating.

5.-12. (canceled)

13. A method for repairing a structurally-damaged region of a gas turbine engine component, the method comprising:
preparing an MCrAlY slurry comprising an MCrAlY powder, a braze powder, a binder, and a dilutant;
applying the MCrAlY slurry over the structurally-damaged area of the gas turbine engine component; and
heating the MCrAlY slurry to a predetermined temperature exceeding the melting point of the braze powder to form an MCrAlY coating and repair the structurally-damaged region of the gas turbine engine component;
wherein the MCrAlY powder consists essentially of:
about 7.5-8.5 wt. % aluminum;
about 20-22 wt. % chromium;
about 38-40 wt. % cobalt;
about 0.2-0.6 wt. % yttrium; and
the balance nickel.

14. A method according to claim 13 wherein the structurally damaged region comprises an eroded portion of the gas turbine engine component, wherein the step of applying comprises applying the MCrAlY slurry in successive coats to build-up an MCrAlY coating over the eroded portion, and wherein the method further comprises the step of:
machining the MCrAlY coating to restore the repaired area approximately to its original dimensions and contours.

15. A method according to claim 13 wherein the structurally damaged area includes at least one crack, and wherein the step of heating comprises heating the MCrAlY slurry to a predetermined temperature surpassing the melting point of the braze powder to cause the melted braze powder along with the MCrAlY powder to flow into the crack.

16. A method according to claim 13 wherein the step of applying comprises brushing, dipping, spraying, or a combination thereof.

17. A method according to claim 13 wherein the MCrAlY powder and the braze powder are mixed in a predetermined ratio ranging from about 50 wt. % to about 60 wt. % MCrAlY powder with about 40 wt. % to about 50 wt. % braze powder.

18. A method according to claim 13 wherein the braze powder comprises:
about 3.6-5.2 wt. % aluminum;
about 2.3-3.2 wt. % boron;
about 0.02-0.06 wt. % carbon;
about 6.7-9.2 wt. % chromium;
about 9.7-10.3 wt. % cobalt;
about 1.3-4.0 wt. % hafnium;
about 1.4-3.2 wt. % rhenium;
about 3.3-6.3 wt. % tantalum;
about 3.7-4.7 wt. % tungsten; and
the balance nickel.

19. A method according to claim 13 wherein the braze powder comprises:
about 0.4-0.8 wt. % carbon;
about 2.5-3.0 wt. % boron;
about 22.5-23.5 wt. % chromium;
about 9.5-10.5 wt. % nickel;
about 3.3-3.9 wt. % tantalum;
about 0.1-0.3 wt. % titanium;
about 6.5-7.5 wt. % tungsten;
about 0.03-0.07 wt. % yttrium;
about 0.3-0.7 wt. % zirconium and the balance cobalt.

20. A method according to claim 13 wherein the braze powder comprises:
about 3.2-4.0 wt. % aluminum;
about 2.5-3.0 wt. % boron;
about 13.5-14.5 wt. % chromium;
about 9.5-10.5 wt. % cobalt;
about 2.2-2.8 wt. % tantalum;
about 0.05-0.15 wt. % tungsten; and
the balance nickel.

21. A method according to claim 13 wherein the dilutant comprises an alcohol, and wherein the method further comprises the step of curing the MCrAlY slurry to evaporate at least a portion of the alcohol therefrom, the step of curing performed prior to the step of heating.

22. A method according to claim 13 wherein the braze powder comprises one of the group consisting of:
a first braze powder, comprising:
about 3.6-5.2 wt. % aluminum;
about 2.3-3.2 wt. % boron;
about 0.02-0.06 wt. % carbon;
about 6.7-9.2 wt. % chromium;
about 9.7-10.3 wt. % cobalt;
about 1.3-4.0 wt. % hafnium;
about 1.4-3.2 wt. % rhenium;
about 3.3-6.3 wt. % tantalum;
about 3.7-4.7 wt. % tungsten; and
the balance nickel;
a second braze powder, comprising:
about 0.4-0.8 wt. % carbon;
about 2.5-3.0 wt. % boron;
about 22.5-23.5 wt. % chromium;
about 9.5-10.5 wt. % nickel;
about 3.3-3.9 wt. % tantalum;
about 0.1-0.3 wt. % titanium;
about 6.5-7.5 wt. % tungsten;
about 0.03-0.07 wt. % yttrium;
about 0.3-0.7 wt. % zirconium and
the balance cobalt; and
a third braze powder, comprising:
about 3.2-4.0 wt. % aluminum;
about 2.5-3.0 wt. % boron;
about 13.5-14.5 wt. % chromium;
about 9.5-10.5 wt. % cobalt;
about 2.2-2.8 wt. % tantalum;
about 0.05-0.15 wt. % tungsten; and
the balance nickel.

23.-24. (canceled)
